(19) United States
(12) Patent Application Publication
(10) Pub. No.: US 2025/0286902 A1
(43) Pub. Date: Sep. 11, 2025

(54) LOG DETERMINATION METHOD, LOG DETERMINATION DEVICE, AND STORAGE MEDIUM STORING LOG DETERMINATION PROGRAM

(71) Applicant: DENSO CORPORATION, Kariya-city (JP)

(72) Inventors: Ryosuke MURAKAMI, Kariya-city (JP); Tatsuro KAWAKAMI, Kariya-city (JP)

(21) Appl. No.: 19/051,241

(22) Filed: Feb. 12, 2025

(30) Foreign Application Priority Data
Mar. 8, 2024 (JP) 2024-036349

(51) Int. Cl. H04L 9/40

(52) U.S. Cl. CPC H04L 63/1425; H04L 63/1416; H04L 63/1433

(57) ABSTRACT

A log determination method includes acquiring a security log from a first security sensor that generates a security log when an event is detected, acquiring first operation information indicating whether the first security sensor is operating normally and second operation information indicating whether a second security sensor different from the first security sensor is operating normally, respectively, when the security log indicates an abnormal log showing an abnormal event, determining a reliability of the abnormal log based on the first operation information and the second operation information, and outputting the reliability.

### CROSS REFERENCE TO RELATED APPLICATION

This application is based on Japanese Patent Application No. 2024-036349 filed on Mar. 8, 2024, the disclosure of which is incorporated herein by reference.

### TECHNICAL FIELD

The present disclosure relates to a log determination method, device, and a program capable of determining the reliability of a security log generated by a security sensor of an electronic control device mainly mounted on a movable object such as an automobile.

### BACKGROUND

A related art describes acquiring detection information indicating a detection of an abnormality from a monitoring sensor, determining whether to transmit the detection information based on an impact of the abnormality on the vehicle indicated by the detection information and on the degree of matching in pattern matching between the detection information and an abnormal pattern indicating a combination of the detection location and type of abnormality. Only the detection information determined to be necessary for transmission is transmitted to an external monitoring system.

### SUMMARY

A log determination method includes acquiring a security log from a first security sensor that generates a security log when an event is detected, acquiring first operation information indicating whether the first security sensor is operating normally and second operation information indicating whether a second security sensor different from the first security sensor is operating normally, respectively, when the security log indicates an abnormal log showing an abnormal event, determining a reliability of the abnormal log based on the first operation information and the second operation information, and outputting the reliability.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating the arrangement of the log determination device in each embodiment and relationship with a related device;

FIG. 2 is a diagram illustrating the arrangement of the log determination device in each embodiment and relationship with a related device;

FIG. 3 is a diagram illustrating a configuration example of the electronic control system in each embodiment;

FIG. 4 is a diagram illustrating the configuration of the electronic control device in each embodiment;

FIG. 5 is a diagram illustrating the security log generated by the security sensor of the electronic control device in each embodiment;

FIG. 6 is a block diagram showing a configuration example of the log determination device in the first embodiment;

FIG. 7 is a diagram illustrating the abnormal log and the security log in the first embodiment;

FIG. 8 is a flowchart illustrating the operation of the log determination device in the first embodiment;

FIG. 9 is a flowchart illustrating the operation of the log determination device in the first embodiment;

FIG. 10 is a flowchart illustrating the operation of the log determination device in the second embodiment;

FIG. 11 is a flowchart illustrating the operation of the log determination device in the third embodiment; and

FIG. 12 is a diagram illustrating a configuration example of a log determination system in a modified example in each embodiment.

### DETAILED DESCRIPTION

In recent years, technologies such as V2X, including inter-vehicle communication and road-vehicle communication, as well as driving assistance and autonomous driving control, have been attracting attention. As a result, a vehicle has a communication function, and a so-called connectivity of the vehicle is progressing. As a result, a possibility that a vehicle may receive a cyberattack called unauthorized access is increasing.

Therefore, it is necessary to analyze the cyberattack on vehicles and to construct countermeasures against the cyberattack. Accordingly, it is considered to transmit information related to abnormalities occurring in a vehicle to an external server or the like with sufficient resources to analyze cyberattacks. However, since an external server or the like needs to process information transmitted from multiple vehicles, the processing burden is significant.

Here, as a result of detailed examination, the inventors of this application have found the following. In a related art, it is assumed that the detection information acquired from the monitoring sensor is accurate, and the determination of whether to transmit the detection information is made based on this assumption. However, if the monitoring sensor itself is not operating normally or if the detection information is generated due to some malfunction, the detection information itself may not be accurate. Transmitting inaccurate detection information to an external monitoring system not only reduces the accuracy of analysis by the monitoring system using such detection information but also increases the processing load on the monitoring system or the transmission load from the vehicle to the monitoring system. Therefore, it may be desirable to determine the reliability of the detection information and transmit only highly reliable detection information to the monitoring system or to analyze cyberattacks considering the reliability of the detection information.

The present disclosure provides a technique to implement a log determination method and the like that can determine the reliability of security logs acquired from security sensors.

According to one aspect of the present disclosure, a log determination method includes acquiring a security log from a first security sensor that generates a security log when an event is detected, acquiring first operation information indicating whether the first security sensor is operating normally and second operation information indicating whether a second security sensor different from the first security sensor is operating normally, respectively, when the security log indicates an abnormal log showing an abnormal event, determining a reliability of the abnormal log based on the first operation information and the second operation information, and outputting the reliability.

According to this configuration, the log determination method and the like of the present disclosure can determine the reliability of security logs.

Hereinafter, embodiments of the present disclosure will be described with reference to the drawings.

When there are multiple embodiments, the configurations disclosed in each embodiment are not limited to each embodiment and can be combined across the embodiments. For example, a configuration disclosed in one embodiment may be combined with other embodiments. The disclosed configurations in respective multiple embodiments may be partially combined.

### 1. Configuration Premises of Each Embodiment

(1) Arrangement of the Log Determination Device and Relationship with Related Devices

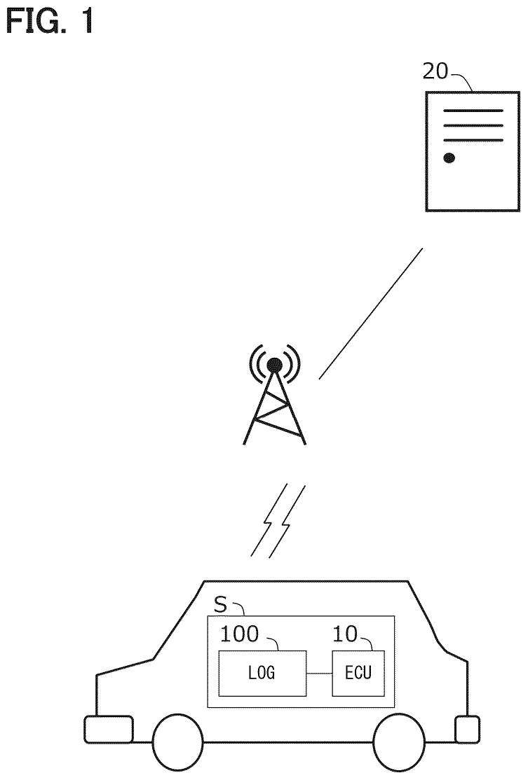

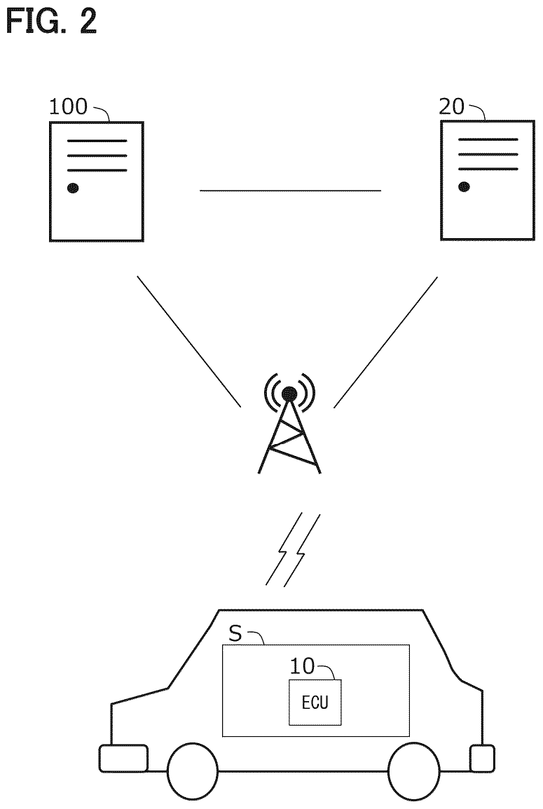

FIG. 1 and FIG. 2 are diagrams illustrating the arrangement of the log determination device in each embodiment and its relationship with related devices. For example, as shown in FIG. 1, it is assumed that the log determination device 100 is “mounted” on a vehicle, which is a “movable object,” together with the electronic control device 10 configuring the electronic control system S. As shown in FIG. 2, it is assumed that the electronic control device 10 configuring the electronic control system S is mounted on a vehicle, and the log determination device 100 is realized by a server device or the like provided outside the vehicle. In the following embodiments, the case where the log determination device 100 is mounted on a vehicle as shown in FIG. 1 will be described. Even in the case where the log determination device 100 is not mounted on a vehicle as shown in FIG. 2, the communication method with the electronic control device 10 is different, but the description of each embodiment is cited as it is the same.

Here, the “movable object” refers to an object that can move, and the moving speed is arbitrary. It also naturally includes cases where the movable object is stopped. Examples include an automobile, a motorcycle, a bicycle, a pedestrian, a ship, an aircraft, and any object mounted thereon, but are not limited to these. The term “mounted” includes not only cases where an object is directly fixed to the movable object but also cases where the object is moved together with the movable object although it is not fixed to the movable object. For example, it includes cases where a person on the movable object carries it or where it is mounted on luggage placed on the movable object.

The log determination device 100 is connected to an “electronic control device” (also referred to as Electronic Control Unit, ECU) configuring the electronic control system S. The log determination device 100 is a device that acquires a security log generated by security sensors mounted on multiple ECUs 10 configuring the electronic control system S and determines the security logs.

Here, the “electronic control device” may be not only a physically independent electronic control device but also a virtualized electronic control device realized using virtualization technology.

The external device 20 is any device provided outside the vehicle, and examples include a Security Operations Center (SOC) that detects and analyzes cyberattacks.

In FIG. 1, the electronic control system S and the external device 20 are connected via a communication network using a wireless communication method such as IEEE 802.11 (Wi-Fi (registered trademark)), IEEE 802.16 (WiMAX (registered trademark)), W-CDMA (Wideband Code Division Multiple Access), HSPA (High Speed Packet Access), LTE (Long Term Evolution), LTE-A (Long Term Evolution Advanced), 4G, 5G, or the like. Alternatively, DSRC (Dedicated Short Range Communication) may be used. When the vehicle is parked in a parking lot or housed in a repair shop, a wired communication method may be used instead of a wireless communication method. For example, a LAN (Local Area Network), the Internet, or a fixed telephone line may be used. Additionally, a line combining wireless and wired communication methods may also be used. For example, the electronic control system S and a base station device in a cellular system may be connected by a wireless communication method such as 4G, and the base station device and the external device 20 may be connected by a wired communication method such as a backbone line of a communication carrier or the Internet. A gateway device may be provided at the junction between the backbone line and the Internet.

In FIG. 2, the electronic control system S and the log determination device 100 provided outside the vehicle are also connected via a communication network using the aforementioned wireless or wired communication methods. In FIG. 2, the log determination device 100 and the external device 20 are described as separate devices connected by a communication network, but the log determination device 100 and the external device 20 may be realized as the same device.

The log determination device 100 mounted on a vehicle as shown in FIG. 1 is also referred to as a detection master in the specification defined by AUTOSAR (AUTomotive Open System ARchitecture).

### (2) Configuration of the Electronic Control System S

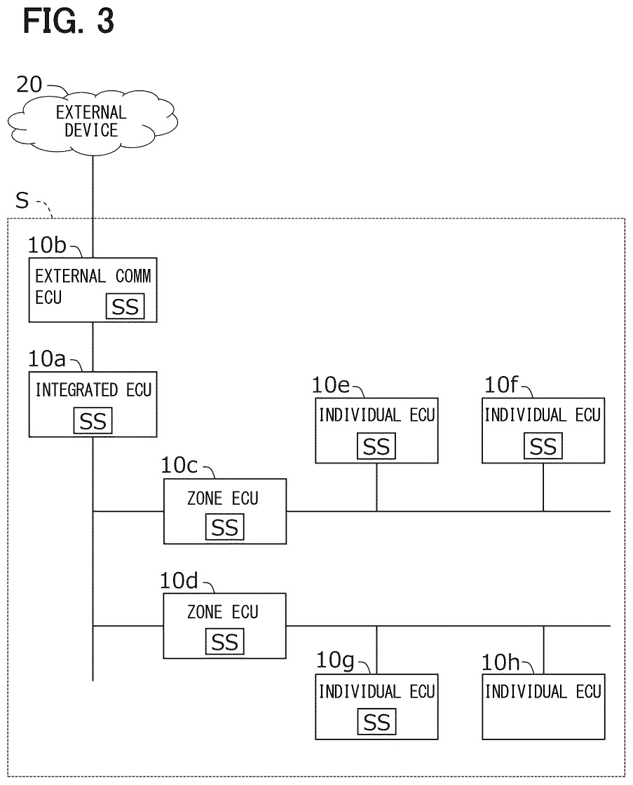

FIG. 3 is a diagram showing a configuration example of the electronic control system S. The electronic control system S includes multiple ECUs 10 and an in-vehicle network connecting them. FIG. 3 exemplifies eight ECUs (ECUs 10a to 10h). However, the electronic control system S may include any number of ECUs. In the following description, when a single or multiple electronic control devices are collectively described, they are referred to as the ECU 10 and each ECU 10. When the individual electronic control devices are specified and described, they are referred to as the ECU 10a, the ECU 10b, the ECU 10c, and so on.

In the case of FIG. 3, each ECU 10 is connected via an in-vehicle communication network such as a CAN (Controller Area Network) or a LIN (Local Interconnect Network). Alternatively, they may be connected via any communication method, whether wired or wireless, such as Ethernet (registered trademark), Wi-Fi (registered trademark), or Bluetooth (registered trademark). The connection refers to a state in which data can be exchanged and includes cases where different hardware is connected via a wired or wireless communication network, as well as cases where virtual ECUs (also referred to as virtual machines) realized on the same hardware are virtually connected.

The electronic control system S shown in FIG. 3 includes an integrated ECU 10a, an external communication ECU 10b, zone ECUs (10c, 10d), and individual ECUs (10e to 10h).

The integrated ECU 10a is an ECU having a function of controlling the entire electronic control system S and a gateway function that mediates communication between the ECUs. The integrated ECU 10a may also be referred to as a gateway ECU (G-ECU) or a mobility computer (MC). The integrated ECU 10a may also be a relay device or a gateway device.

The external communication ECU 10b is an ECU having a communication unit that communicates with an external device 20 provided outside the vehicle. The communication method used by the external communication ECU 10b is the aforementioned wireless or wired communication method. To realize multiple communication methods, multiple external communication ECUs 10b may be provided. Alternatively, the integrated ECU 10a may include the function of the external communication ECU 10b instead of providing the external communication ECU 10b.

The zone ECUs (10c, 10d) are ECUs with gateway functions appropriately arranged according to the location or function of the individual ECUs. For example, the zone ECU 10c is an ECU with a gateway function that mediates communication between the individual ECUs 10e and 10f arranged at the front of the vehicle and other ECUs 10. The zone ECU 10d is an ECU having a gateway function that mediates communication between the individual ECUs 10g and 10h arranged at the rear of the vehicle and other ECUs 10.

The individual ECUs (10e to 10h) can be configured with ECUs having any function. Examples include a drive system electronic control device that controls the engine, a steering wheel, a brake, etc., a vehicle body system electronic control device that controls a meter, a power window, etc., an information system electronic control device such as a navigation device, or a safety control system electronic control device that performs control to prevent collisions with an obstacle or a pedestrian. The ECUs may be classified as masters and slaves instead of being in parallel.

In the electronic control system S of FIG. 3, security sensors are mounted on each ECU 10 except for the ECU 10h (abbreviated as SS in the drawing). Thus, it is not necessary to mount security sensors on all ECUs 10 configuring the electronic control system S. The security logs generated by the security sensors will be described later.

In each embodiment, the log determination device 100 is described as being provided in the integrated ECU 10a. However, the log determination device 100 may be provided in the external communication ECU 10b, the zone ECUs (10c to 10d), or the individual ECUs (10e to 10h). When provided in one of the individual ECUs (10e to 10h), it is desirable to use a dedicated ECU to realize the log determination device 100.

### (3) Security Sensor

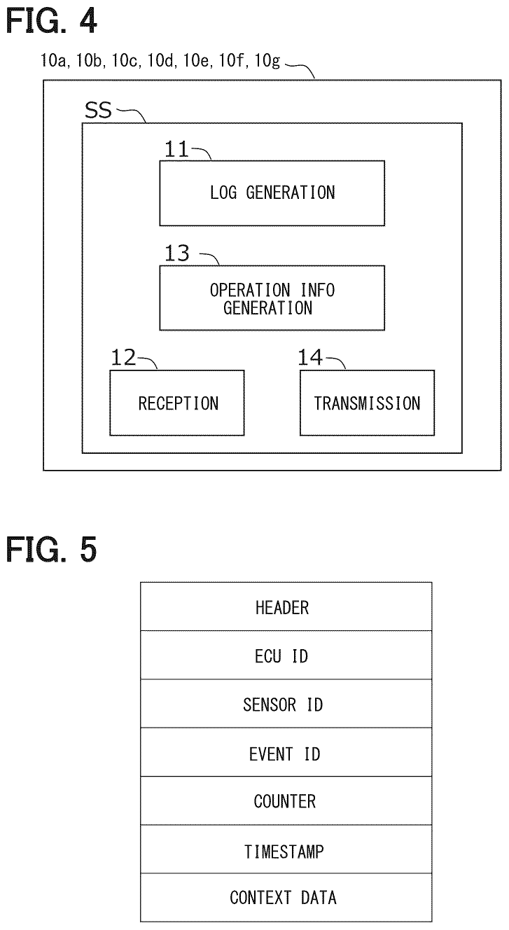

FIG. 4 is a block diagram showing the configuration of ECUs (10a to 10g) equipped with security sensors. The ECUs (10a to 10g) include a log generation unit 11, a reception unit 12, an operation information generation unit 13, and a transmission unit 14.

The log generation unit 11 generates a security log when an event occurs on the ECU 10 or on the network connected to the ECU 10. For example, when an abnormal event occurs due to a cyberattack on the ECU 10 or the network, the log generation unit 11 generates a security log. The log generation unit 11 may generate a security log not only when an abnormal event is detected but also when a normal event is detected.

FIG. 5 shows a specific example of a security log generated by the log generation unit 11. The security log includes fields such as an ECU ID indicating the identification information of the ECU 10 on which the security sensor is mounted, a sensor ID indicating the identification information of the security sensor, an event ID indicating the identification information of the security event, a counter indicating the number of occurrences of the event, a timestamp indicating the occurrence time of the event, and context data indicating the details of the output of the security sensor. The security log may further include a header storing information indicating the version of the protocol and the state of each field.

The reception unit 12 receives a transmission request for operation information from the log determination device 100 via the in-vehicle network. When the security sensor and the log determination device 100 are mounted on the same ECU 10, the reception unit 12 directly receives the request from the hardware or software realizing the log determination device 100 without using the in-vehicle network. The transmission request for operation information will be described later. The reception unit 12 may also receive a request to perform a test to check whether the security sensor is operating normally in addition to the transmission request for operation information.

The operation information generation unit 13 generates operation information “indicating” whether the security sensor is operating normally when the reception unit 12 receives a transmission request for operation information. When the reception unit 12 receives a request to perform a test to check whether the security sensor is operating normally along with the transmission request for operation information, the operation information generation unit 13 performs a test to check whether the security sensor is operating normally and generates the “test result” as operation information. In this case, the operation information generation unit 13 may have a test function for the security sensor, or the security sensor may have a test execution unit (not shown) separate from the operation information generation unit 13.

Here, “indicating” whether the security sensor is operating normally refers to information that directly or indirectly indicates whether the security sensor is operating normally. Directly indicating information includes information that contains an evaluation, such as information indicating that the security sensor is operating normally or information indicating that the security sensor is not normally operating. Indirectly indicating information includes information that does not contain an evaluation, such as the output value or setting value of the security sensor, which can be evaluated as normal or not based on evaluation criteria. The “test result” may be the result indicating whether or not the security sensor is operating normally based on the test, or the data output by the test itself.

An example of a test to check whether the security sensor is operating normally is to generate a pseudo event within the ECU 10 and have the security sensor detect this event. For example, if the security sensor detects a pseudo event generated within the ECU 10 and generates a security log containing the event ID of the pseudo event, the counter of the occurrence of the pseudo event, appropriate ECU ID, or the like, it can be said that the security sensor is operating normally. Therefore, the operation information generation unit 13 generates operation information indicating that the security sensor is operating normally.

On the other hand, if the security sensor cannot detect the pseudo event or cannot generate an appropriate security log for the pseudo event, it can be said that the security sensor is not operating normally. In this case, the operation information generation unit 13 generates operation information indicating that the security sensor is not operating normally.

The operation information indicating the test result may be information indicating that the security sensor is operating normally or not operating normally, but it is not limited to this. For example, the operation information generation unit 13 may generate the security log itself generated for the pseudo event as operation information. In this case, instead of the security sensor, the log determination device 100 determines whether the security sensor is operating normally using the security log generated for the pseudo event.

The operation information generation unit 13 may also generate the setting information of the security sensor as operation information. The setting information of the security sensor includes, for example, the types of events that the security sensor can detect, the criteria or thresholds for the security sensor to detect events. When the operation information indicates the setting information of the security sensor, the log determination device 100 determines whether the security sensor is operating normally using the operation information.

In the first embodiment described below, the reception unit 12 receives a request to perform a test along with the transmission request for operation information, and the operation information generation unit 13 generates operation information indicating the test result of the security sensor. In the second embodiment, the reception unit 12 receives only the transmission request for operation information, and the operation information generation unit 13 generates the setting information of the security sensor as operation information.

The operation information generation unit 13 may also generate operation information at a timing when the reception unit 12 has not received a transmission request for operation information. For example, the operation information generation unit 13 may generate operation information at “regular intervals” and/or at the timing when the log generation unit 11 generates a security log. When the operation information generation unit 13 generates operation information at regular intervals, the interval may vary depending on the driving conditions of the vehicle. For example, the interval may be shortened when the vehicle speed is above a certain speed and lengthened when the vehicle speed is below a certain speed.

The term “regular intervals” includes not only cases where the intervals are always constant but also cases where the intervals are determined by conditions.

The operation information generation unit 13 may also generate operation information when the security sensor or the ECU 10 having the security sensor is started. The operation information generation unit 13 may further generate stop information, which is operation information indicating the stop of the security sensor, when the security sensor or the ECU 10 having the security sensor is stopped.

The term “stop” refers to the state where the security sensor transitions from an operating state to a non-operating state, including cases where the power is turned off from on, as well as cases where the security sensor enters a sleep state.

Returning to FIG. 4, the transmission unit 14 transmits the security log generated by the log generation unit 11 and the operation information generated by the operation information generation unit 13 to the log determination device 100 via the in-vehicle network. When the security sensor and the log determination device 100 are mounted on the same ECU 10, the transmission unit 14 directly outputs to the hardware or software realizing the log determination device 100 without using the in-vehicle network.

The security log generated by the security sensor is called SEv, and the filtered and qualified security log is called QSEv. For example, the security sensor generates SEv and reports it to the intrusion detection system manager (IdsM). When SEv passes the certification filter and meets the specified criteria in IdsM, it is transmitted as QSEv from the intrusion detection reporter to the outside of the vehicle. The security logs in each embodiment include both SEv and QSEv. When the security log is QSEv, the range including the Intrusion Detection System Manager (IdsM) corresponds to the log generation unit 11, and the Intrusion Detection Reporter corresponds to the transmission unit 14.

### 2. First Embodiment

### (1) Configuration of the Log Determination Device 100

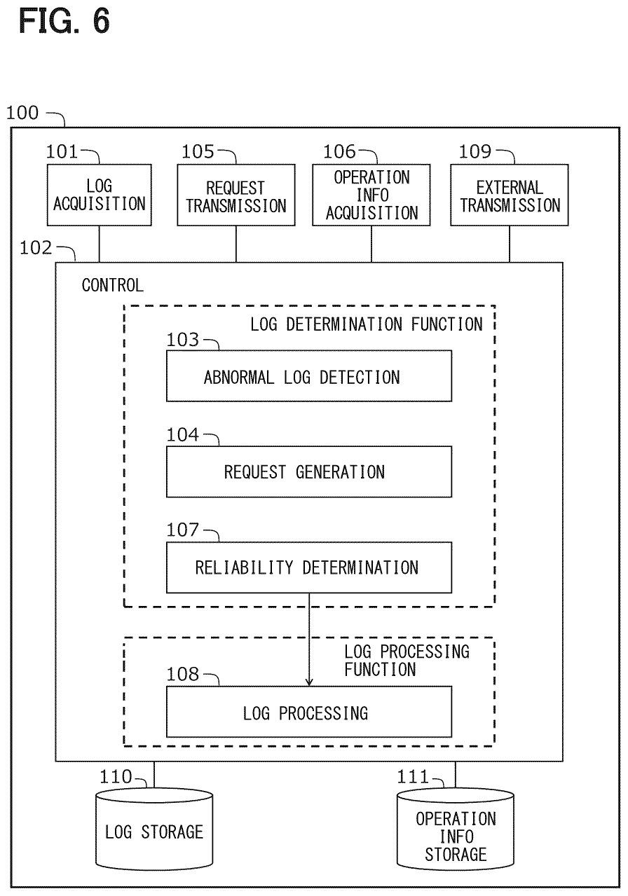

FIG. 6 is a block diagram showing a configuration example of the log determination device 100 in the present embodiment. The log determination device 100 includes a log acquisition unit 101, a control unit 102, a request transmission unit 105, an operation information acquisition unit 106, an external transmission unit 109, a log storage unit 110, and an operation information storage unit 111. The control unit 102 mainly realizes two functions, namely a log determination function and a log processing function. Specifically, the control unit 102 realizes an abnormal log detection unit 103, a request generation unit 104, and a reliability determination unit 107 as the log determination function, and a log processing unit 108 as the log processing function, by hardware and/or software.

The log acquisition unit 101 acquires the security log generated by the security sensor from the security sensor. The log acquisition unit 101 acquires the security log from the security sensors mounted on the ECUs 10 other than the integrated ECU 10a via the in-vehicle network and directly acquires the security log from the security sensors mounted on the integrated ECU 10a without using the in-vehicle network.

The abnormal log detection unit 103 detects a security log indicating an abnormal event from the security logs acquired by the log acquisition unit 101. Hereinafter, a security log indicating an abnormal event is referred to as an abnormal log. The abnormal log detection unit 103 detects an abnormal log based on one or more security logs. For example, the abnormal log detection unit 103 detects a security log as an abnormal log when the event ID included in the security log is a specific event ID indicating an abnormal event. Alternatively, the abnormal log detection unit 103 detects these security logs as abnormal logs when the combination of event IDs of multiple security logs acquired by the log acquisition unit 101 per unit time is a specific combination of event IDs. In another example, the abnormal log detection unit 103 may detect these security logs as abnormal logs when the log acquisition unit 101 acquires a number of security logs having a specific event ID exceeding a predetermined number per unit time.

The request generation unit 104 generates a transmission request requesting the transmission of operation information (corresponding to the “first operation information”) indicating whether the security sensor (corresponding to the “first security sensor”) that is the source of the abnormal log is operating normally when the abnormal log detection unit 103 detects an abnormal log. Hereinafter, the security sensor that is the source of the abnormal log is referred to as the first security sensor, the operation information requested from the first security sensor is referred to as the first operation information, and the transmission request requesting the transmission of the first operation information is referred to as the first transmission request.

Here, when the abnormal log detection unit 103 detects multiple security logs as abnormal logs, the sources of these security logs are not necessarily one security sensor. That is, the abnormal log detection unit 103 may detect multiple security logs transmitted from multiple security sensors as abnormal logs. In such cases, the request generation unit 104 generates transmission requests for all the security sensors that are the sources of the abnormal logs.

The request generation unit 104 further selects one or more security sensors (corresponding to the “second security sensor”) different from the security sensor that is the source of the abnormal log and generates transmission requests requesting from the selected security sensor, the transmission of operation information (corresponding to the “second operation information”) indicating whether the selected security sensor is operating normally. Hereinafter, the security sensor different from the first security sensor is referred to as the second security sensor, the operation information requested from the second security sensor is referred to as the second operation information, and the transmission request requesting the transmission of the second operation information is referred to as the second transmission request. Details of the second security sensor selected by the request generation unit 104 will be described later.

In the present embodiment, the request generation unit 104 generates the first transmission request and the second transmission request requesting the “test result” indicating whether the first security sensor and the second security sensors are operating normally as operation information.

The request generation unit 104 of the present embodiment further generates an execution request requesting the execution of a test to check whether the security sensors are operating normally. Hereinafter, the execution request requesting the execution of a test for the first security sensor is referred to as the first execution request, and the execution request requesting the execution of a test for the second security sensors is referred to as the second execution request. The first execution request and the second execution request may further indicate the contents of the pseudo events used in the test by the security sensors.

The request transmission unit 105 transmits the first transmission request and the first execution request generated by the request generation unit 104 to the first security sensor and transmits the second transmission request and the second execution request to the second security sensors.

The operation information acquisition unit 106 acquires the first operation information and the second operation information from the first security sensor and the second security sensors, respectively.

Here, when the operation information generation unit 13 of the security sensor generates operation information at the time of starting of the security sensor, stopping, at regular intervals, or at the timing when the log generation unit 11 generates a security log, the operation information acquisition unit 106 further acquires the operation information generated at these timings.

The reliability determination unit 107 determines the “reliability” “related to” the abnormal log based on the first operation information and the second operation information acquired by the operation information acquisition unit 106, and outputs the determined reliability to the log processing unit 108, which will be described later. How the reliability determination unit 107 determines the reliability related to the abnormal log based on the first operation information and the second operation information will be described later.

Here, “reliability” is an index classified based on predetermined evaluation criteria, and the number of classifications may be multiple. The term “related to” the abnormal log includes not only the abnormal log itself but also logs related to the abnormal log.

Here, when the security log itself generated for the pseudo event by the security sensor is used as operation information, the reliability determination unit 107 determines whether the security log acquired as operation information is appropriate as a security log generated for the pseudo event, for example, whether the security log includes the event ID of the pseudo event and the appropriate ECU ID, and uses the determination result to determine the reliability related to the abnormal log.

In the present embodiment, the reliability determination unit 107 determines whether the reliability related to the abnormal log is high or low, but the reliability may be further finely classified. For example, it may be classified into high/medium/low, or the reliability may be determined numerically. For example, based on the number of operation information indicating that the security sensor is operating normally or not among the multiple operation information acquired from the multiple second security sensors, or the ratio of operation information indicating that the security sensor is operating normally to operation information indicating that the security sensor is not operating normally, the reliability may be determined numerically.

For example, if the first operation information indicates that the first security sensor is operating normally, and ¾ of the second operation information acquired from the multiple second security sensors indicate that they are operating normally while ¼ indicate that they are not operating normally, the reliability related to the abnormal log is determined to be 75%.

However, if the first operation information indicates that the first security sensor is not operating normally, the reliability related to the abnormal log generated by the first security sensor is likely to be low. Therefore, if the first operation information indicates that the first security sensor is not operating normally, it may be desirable to determine that the reliability related to the abnormal log is low even if the second operation information indicates that all the multiple second security sensors are operating normally.

Additionally, if the operation information acquisition unit 106 does not acquire the first operation information and the second operation information in response to the first transmission request and the second transmission request, the reliability determination unit 107 may determine that the security sensor for which operation information is not acquired is not operating normally.

The log processing unit 108 discards the abnormal log when the reliability output from the reliability determination unit 107 is “lower than” a predetermined reliability. If a cyberattack analysis is conducted using an abnormal log with low reliability, the analysis accuracy may decrease. Furthermore, transmitting an abnormal log with low reliability to the external device 20 increases the transmission load on the network between the electronic control system S and the external device 20. Therefore, by discarding abnormal logs with low reliability, the processing load related to attack analysis is suppressed, and the transmission load on the network is reduced.

The term “lower than” includes both cases where it includes the same value as the comparison target and cases where it does not.

The external transmission unit 109 transmits the abnormal log determined to have a reliability “higher than” the predetermined reliability by the reliability determination unit 107 to the external device 20 via the external communication ECU 10b.

The external transmission unit 109 may also transmit a security log that is not determined to be an abnormal log to the external device 20 in addition to the abnormal log. For example, in addition to the abnormal log, the external transmission unit 109 may transmit the security log acquired within a predetermined time from the time when the log determination device 100 acquired the abnormal log to the external device 20 along with the abnormal log.

In the present embodiment, the log processing unit 108 is described as discarding an abnormal log with reliability lower than the predetermined reliability. However, the log processing unit 108 may store the abnormal log instead of discarding the abnormal log. In this case, the log processing unit 108 may store the abnormal log with low reliability in the log storage unit 110, which will be described later, or in a memory (not shown) provided outside the log determination device 100. In another example, the abnormal log with low reliability may be transmitted to the external device 20 without being discarded. In this case, in the analysis of cyberattacks, the reliability related to the abnormal log is considered, and the analysis of cyberattacks using the abnormal log can be performed. Therefore, in addition to the abnormal log, the reliability determined by the reliability determination unit 107 and/or the first operation information and the second operation information are transmitted to the external device 20. For example, the log processing unit 108 stores the reliability information in the context data of the abnormal log, and the external transmission unit 109 transmits the abnormal log with the reliability information stored to the external device 20.

The log storage unit 110 stores the security log acquired by the log acquisition unit 101. The operation information storage unit 111 stores the operation information acquired by the operation information acquisition unit 106. The log storage unit 110 and the operation information storage unit 111 may be external storage devices (hard disks, USB memory, CD/BD, etc.) or internal storage devices (RAM, etc.). They may be either volatile or non-volatile.

### (2) Selection of Security Sensors and Determination of Reliability

Next, the selection of the second security sensors by the request generation unit 104 and the determination of reliability using the first operation information and the second operation information will be described.

### (a) Security Sensors Mounted on the Same ECU as the First Security Sensor

As an example, the request generation unit 104 selects the security sensors mounted on the same ECU as the first security sensor as the second security sensors.

If the first security sensor is malfunctioning or has a defect that prevents it from operating properly, the security sensor mounted on the same ECU as the first security sensor may also be malfunctioning or have a defect as well. Therefore, by selecting the security sensor mounted on the same ECU as the first security sensor as the second security sensor and determining the reliability of the abnormal log based on the operation information of the first security sensor and these second security sensors, the reliability of the abnormal log can be determined with higher accuracy.

For example, if neither the first security sensor nor the second security sensor is working normally, the ECU itself may be faulty, and the first security sensor has likely detected an abnormal event caused by a malfunction in the ECU. Therefore, the reliability of the log generated by the ECU, i.e., the abnormal log, will be low. In contrast, if both the first and second security sensors are operating normally, the first security sensor may have detected an abnormal event caused by a cyberattack, and the abnormal log is more reliable, that is, the reliability of the abnormal logs will be high.

The reliability determination unit 107 in this example may determine as the reliability related to the abnormal logs, the reliability of the logs generated by the first security sensor and the second security sensors mounted on the same ECU in addition to the abnormal logs. The reliability related to the abnormal logs may include, for example, the reliability of the logs generated by the first security sensor and the second security sensor mounted on the same ECU within a predetermined time (e.g., the same day, until the vehicle power is turned off, etc.) from the time the abnormal logs were generated.

The term “same ECU” is not limited to physically independent ECUs. For example, the security sensor mounted on the same virtualized ECU as the first security sensor may be selected as the second security sensor.

### (b) Security Sensors According to the Security Level of Multi-layer Defense

In the electronic control system S mounted on a vehicle, multi-layer defense may be adopted to enhance security against attacks. According to multi-layer defense, security functions are provided hierarchically and multi-layered as countermeasures against attacks. Even if one countermeasure (i.e., the first layer) is breached, the next countermeasure (i.e., the second layer) can defend against the attack, thereby enhancing the defense capability of the electronic control system S. Therefore, in an electronic control system S adopting multi-layer defense, there will be multiple layers with different security levels. Each ECU configuring the electronic control system S will belong to one of the multiple layers divided according to the security level. Therefore, the request generation unit 104 selects the second security sensors according to the security level of the multi-layer defense. Specifically, the request generation unit 104 selects the security sensors mounted on the ECUs providing a security level equal to or lower than the security level of the ECU on which the first security sensor is mounted as the second security sensors.

As an example, a security sensor mounted on an ECU that provides a lower security level than the security level of the ECU on which the first security sensor is mounted is selected as the second security sensor. If an ECU belonging to the second layer of the multi-layer defense is subjected to a cyberattack, it means that the cyberattack has passed through the first layer, which has a lower security level than the second layer. Therefore, it is highly likely that the ECU belonging to the first layer is also subjected to the cyberattack. Thus, the request generation unit 104 selects the security sensor mounted on the ECU providing a lower security level than the ECU on which the first security sensor is mounted as the second security sensor. For example, if the first security sensor is mounted on an ECU belonging to the second layer, the security sensor mounted on the ECU belonging to the first layer is selected as the second security sensor.

If the second security sensor is operating normally and the ECU belonging to the first layer is not subjected to a cyberattack, it is highly likely that the first security sensor mounted on the ECU belonging to the second layer is also not subjected to a cyberattack. Therefore, it is highly likely that the first security sensor detected an abnormal event due to a malfunction or defect, and the reliability of the abnormal log will be low. Conversely, if it is possible that the ECU belonging to the first layer is subjected to a cyberattack, it is highly likely that the first security sensor mounted on the ECU belonging to the second layer is also subjected to the cyberattack. Therefore, the first security sensor is more likely to have detected an abnormal event caused by a cyberattack, and the reliability of the abnormal log is higher.

In another example, the request generation unit 104 may select the security sensor mounted on the ECU providing the same security level as the ECU on which the first security sensor is mounted as the second security sensor. In this case, if the first security sensor is mounted on an ECU belonging to the second layer, the security sensor mounted on the ECU belonging to the same second layer is selected as the second security sensor.

If the second security sensor is not working properly, the first security sensor of the same security level may not be operating normally as well. Therefore, the first security sensor is more likely to have detected an abnormal event due to a malfunction or defect, and the reliability of the abnormal log is lower. Conversely, if the second security sensor is operating normally, the first security sensor is more likely to have detected an abnormal event caused by a cyberattack and the abnormal log is more reliable.

The reliability determination unit 107 in this example may determine, in addition to the abnormal log, the reliability of the log generated by the security sensor installed in the ECU that provides the same or lower security level than the ECU in which the first security sensor is installed, as the reliability level regarding the abnormal log.

### (c) Security Sensor Corresponding to Detected Event

As another example, the request generation unit 104 selects a security sensor that detects an event related to the event detected by the first security sensor as the second security sensor.

For example, if the first security sensor detects a message authentication error as an event, there may be an abnormality related to the message authentication function has occurred within the electronic control system S. Therefore, the request generation unit 104 selects another security sensor that detects an event related to message authentication as the second security sensor. Alternatively, the request generation unit 104 may select a security sensor that monitors an HSM (Hardware Security Module) storing keys used for message authentication as the second security sensor.

For example, if both the first security sensor and the second security sensors are not operating normally, the entire message authentication function within the electronic control system S may be faulty, and the first security sensor may have detected an abnormal event due to a malfunction or defect. Therefore, the reliability of the abnormal log will be low. Conversely, if both the first security sensor and the second security sensors are operating normally, it is likely that no issues have occurred in the message authentication function, and the first security sensor may have detected an abnormal event caused by a cyberattack, and the reliability of the anomaly log is higher.

The reliability determination unit 107 in this example may determine the reliability level of the log generated by the second security sensor that detects an event related to the event detected by the first security sensor, in addition to the abnormal log, as the reliability regarding the abnormal log.

(d) Security Sensors Generating Security Logs Acquired Within a Predetermined Time from the Acquisition Time of the Abnormal Log

When analyzing a cyberattack, not only the abnormal log but also the security logs acquired before and after the abnormal log may contain traces of the cyberattack. Therefore, security logs acquired before and after the abnormal log may also be transmitted to the external device 20. In this example, the request generation unit 104 selects the security sensors that generated the security logs to be transmitted to the external device 20 along with the abnormal log as the second security sensors.

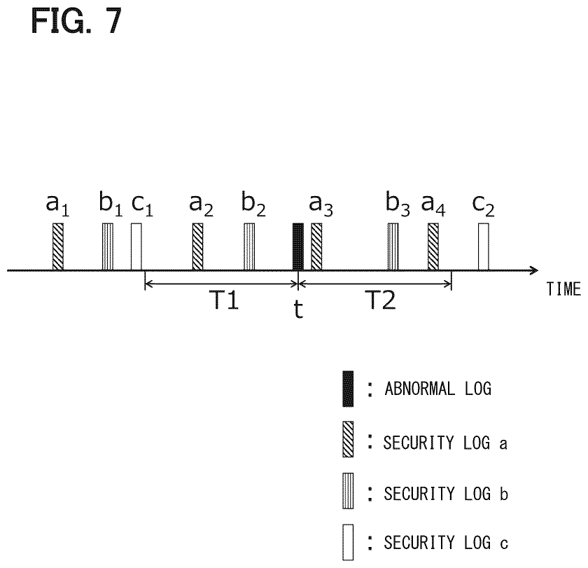

FIG. 7 is a diagram schematically explaining the second security logs in this example. When the log acquisition unit 101 acquires an abnormal log, the request generation unit 104 selects the security sensors that generated the security logs acquired within a predetermined time from the acquisition time of the abnormal log, i.e., within the specified period T1 immediately before the acquisition time (t) of the abnormal log and within the specified period T2 immediately after the acquisition time (t) of the abnormal log, as the second security sensors. In the example of FIG. 7, the security sensors that transmitted security logs a and b are selected as the second security sensors, while the security sensor that transmitted security log c is not selected as the second security sensor.

The external transmission unit 109 transmits the security logs a2, a3, a4, and security logs b2, b3, along with the abnormal log, and the operation information of the security sensors that generated these security logs to the external device 20.

For example, if both the first security sensor and the second security sensors are operating normally, it is highly likely that no malfunctions or defects occurred in the security sensors before and after the time the abnormal log was generated. Therefore, it is highly likely that the first security sensor detected an abnormal event caused by a cyberattack, and the reliability of the abnormal log is higher. Conversely, if both the first security sensor and the second security sensors are not operating normally, there is a possibility that some malfunction occurred within the vehicle before and after the time the abnormal log was generated. Therefore, it is highly likely that the first security sensor detected an abnormal event due to a malfunction, and the reliability of the abnormal log is lower.

The reliability determination unit 107 in this example may determine the reliability related to the abnormal log by evaluating the reliability of the security logs acquired within the specified periods T1 and T2.

(e) Security Sensors from Which Security Logs Have Not Been Acquired Within a Predetermined Time from the Acquisition Time of the Abnormal Log

In this example, the request generation unit 104 selects a security sensor from which a security log has not been acquired within a predetermined time before the acquisition time of the abnormal log as the second security sensor. A security sensor from which a security log has been recently acquired is likely to be operating normally, whereas a security sensor from which a security log has not been recently acquired may not be generating a security log because it is not operating normally. Therefore, the request generation unit 104 selects a security sensor from which a security log has not been acquired within a predetermined time before the acquisition time of the abnormal log as the second security sensor and generates transmission request for operation information.

In this example, it may be desirable to determine the reliability of the abnormal log and a log generated by the second security sensor by considering the ECU on which the selected second security sensor is mounted, the layer of the multi-layer defense to which the ECU belong, and the functions provided by the ECU.

(f) Security Sensors from Which Test Results Have Not Been Acquired Within a Predetermined Time from the Acquisition Time of the Abnormal Log

As another example, the request generation unit 104 selects a security sensor from which operation information, which is the test result conducted by the security sensor, has not been acquired within a predetermined time before the acquisition time of the abnormal log as the second security sensor. In this example, it may be desirable that each security sensor conducts a test at regular intervals or along with the generation of a security log and transmits the test result, which is the operation information, to the log determination device 100.

Similar to the example in (e), in this example, it may be desirable to determine the reliability of the abnormal log and a log generated by the second security sensor by considering the ECU on which the selected second security sensor is mounted, the layer of the multi-layer defense to which the ECU belong, and the functions provided by the ECU.

### (g) Important Security Sensors

The request generation unit 104 may select a security sensor with high importance or high priority as the second security sensor.

For example, the request generation unit 104 may select a security sensor that monitors the firewall for communication between the electronic control system S and the outside of the vehicle as the second security sensor. Cyberattacks from outside the vehicle must pass through the firewall. Therefore, by acquiring the operation information of the security sensor that monitors the firewall, the reliability of the abnormal log indicating an abnormal event can be enhanced.

The above examples (a) to (g) all illustrate one example for selecting a second security sensor, but a combination of these may be used to select a second security sensor. For example, when (a) and (e) are combined, the security sensor on the same ECU as the first security sensor for which no security log has been obtained within a predetermined time period backward from the time when the abnormal log is obtained is selected as the second security sensor. By narrowing down the number of second security sensors in this way and performing transmission requests and the transmission and reception of operation information to/from a subset of sensors that meet specific conditions, the increase in the load on the in-vehicle network can be suppressed.

### (h) Others

The request generation unit 104 may select a security sensor that is not stopped among the security sensors described in (a) to (g) as the second security sensor. The request generation unit 104 can determine whether the security sensor in (a) to (g) is stopped by acquiring stop information, which is operation information indicating the stop of the security sensor when the security sensor is stopped. That is, the request generation unit 104 selects a security sensor among the security sensors in (a) to (g) from which stop information has not been acquired as the second security sensor.

Requesting operation information from a security sensor that is stopped will not yield any operation information. Therefore, requesting operation information from such a security sensor would unnecessarily increase the network load. Hence, the request generation unit 104 does not select a stopped security sensor as the second security sensor.

### (2) Operation of the Log Determination Device 100

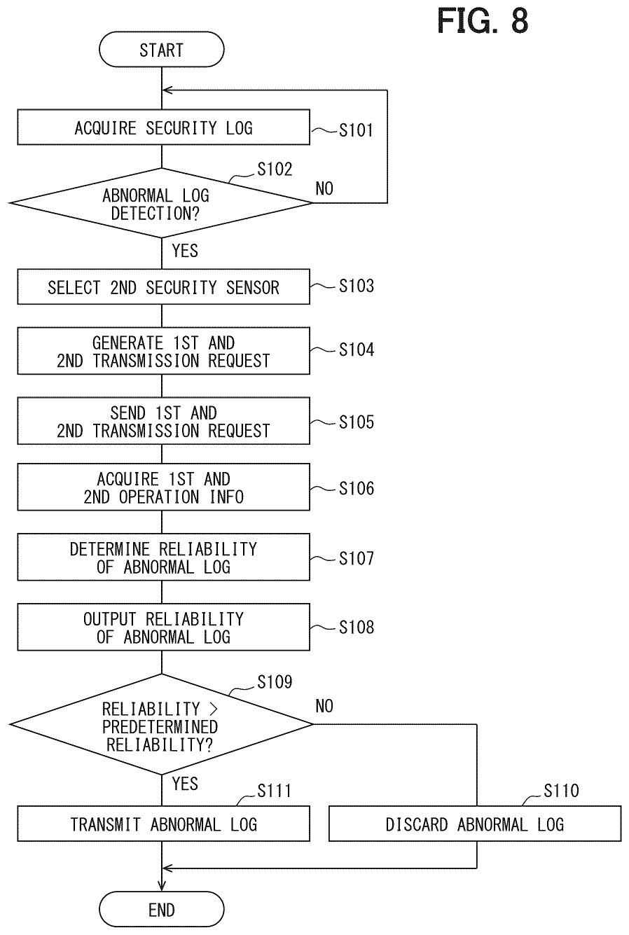

Next, the operation of the log determination device 100 will be described with reference to FIG. 8. FIG. 8 illustrates not only the log determination method executed by the log determination device 100 but also the processing procedure of the log determination program executable by the log determination device 100. These processes are not limited to the order shown in FIG. 8. That is, the order may be changed as long as there is no restriction such as a relation in which the result of the preceding step is used in a certain step. The same applies to the figures showing the log determination methods of the embodiments described later.

The log acquisition unit 101 acquires security logs from the security sensors mounted on each ECU 10 (S101). The acquired security logs are stored in the security log storage unit 110. Here, if the abnormal log detection unit 103 detects an abnormal log from the security logs acquired by the log acquisition unit 101 (S102: Y), the request generation unit 104 selects a second security sensor different from the first security sensor (S103). The request generation unit 104 generates a first transmission request requesting the transmission of the first operation information to the first security sensor and a second transmission request requesting the transmission of the second operation information to the second security sensor selected in S103 (S104). The request transmission unit 105 transmits the first transmission request and the second transmission request generated in S104 (S105).

The operation information acquisition unit 106 acquires the first operation information and the second operation information from the first security sensor and the second security sensor, respectively (S106). The reliability determination unit 107 determines the reliability related to the abnormal log based on the first operation information and the second operation information acquired in S106 (S107). The reliability determination unit 107 outputs the reliability determined in S107 to the log processing unit 108 (S108). Here, if the reliability output in S108 is lower than the predetermined reliability (S109: N), the log processing unit 108 discards the abnormal log (S110). Conversely, if the reliability output in S108 is higher than the predetermined reliability (S109: Y), the log processing unit 108 transmits the abnormal log to the external device 20 (S111).

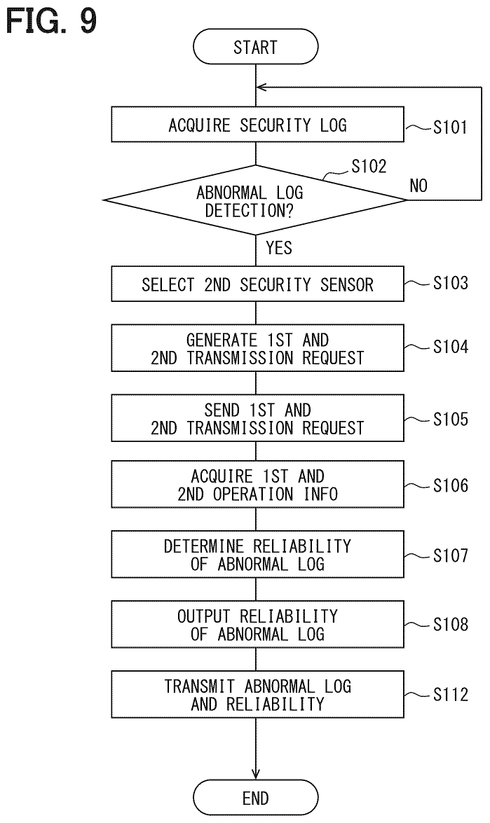

FIG. 9 shows the operation of the log determination device 100 when the abnormal log with low reliability is not discarded. The processes S101 to S108 in FIG. 9 are the same as those in FIG. 8. However, in FIG. 9, the abnormal log and the reliability, which are output in S108, are transmitted to the external device 20 (S112). As mentioned above, in S112, the first operation information and the second operation information may be transmitted to the external device 20 instead of or in addition to the reliability.

### (3) Overview

As described above, according to the present embodiment, it is possible to determine the reliability related to the abnormal log based on the operation information of the first security sensor that generated the abnormal log and the operation information of the second security sensor related to the first security sensor.

Furthermore, by discarding an abnormal log with low reliability and not transmitting it to the external device, the communication load between the log determination device and the external device can be suppressed. Additionally, by discarding the abnormal log or transmitting the reliability related to the abnormal log along with the abnormal log to the external device, the processing load related to the analysis of cyberattacks using the abnormal logs can be suppressed.

### 3. Second Embodiment

In the first embodiment, the log determination device 100 is described as requesting the execution of a test to check whether the security sensor is operating normally and determining the reliability based on the test results as operation information. In the present embodiment, the configuration in which the log determination device 100 determines the reliability using the operation information, which is the setting information of the security sensor, will be described, focusing on the differences from the first embodiment. Since the configuration of the log determination device 100 in the present embodiment is the same as that in the first embodiment, it will be described with reference to FIG. 6.

### (1) Configuration of the Security Sensor

In the present embodiment, the operation information generation unit 13 of the security sensor generates operation information, which is the setting information of the security sensor, not only when the reception unit 12 receives a transmission request for operation information but also when the security sensor “starts.” The transmission unit 14 transmits the operation information generated when the security sensor starts to the log determination device 100.

Here, “start” refers to the state where the security sensor transitions from a non-operating state to an operating state, including cases where the power is turned on from off, as well as cases where the security sensor is awakened from a sleep state.

### (2) Configuration of the Log Determination Device 100

In the present embodiment, the request generation unit 104 generates a first transmission request requesting the transmission of the “operation information,” which is the setting information of the first security sensor, to the first security sensor when the abnormal log detection unit 103 detects an abnormal log. The request generation unit 104 further generates a second transmission request requesting the transmission of the “operation information,” which is the setting information of the second security sensor, to the second security sensor.

Similar to the first embodiment, the request transmission unit 105 transmits the first transmission request generated by the request generation unit 104 to the first security sensor and transmits the second transmission request to the second security sensor. The operation information acquisition unit 106 acquires the first operation information and the second operation information from the first security sensor and the second security sensor, respectively.

The reliability determination unit 107 determines the “reliability” related to the abnormal log based on the first operation information and the second operation information. In the first embodiment, the reliability related to the abnormal log is determined using only the operation information acquired in response to the transmission request, i.e., the test results of the security sensor. In contrast, in the present embodiment, the reliability determination unit 107 determines the reliability by comparing the operation information acquired by the operation information acquisition unit 106 when the security sensor starts with the operation information acquired by the operation information acquisition unit 106 in response to the transmission request.

Specifically, in the present embodiment, the operation information acquisition unit 106 acquires the operation information (corresponding to the “third operation information”), which is the setting information of the first security sensor, when the first security sensor starts. The operation information acquisition unit 106 further acquires the operation information (corresponding to the “fourth operation information”), which is the setting information of the second security sensor, when the second security sensor starts. These operation information are stored in the operation information storage unit 111.

The reliability determination unit 107 determines whether the first security sensor and the second security sensor are operating normally based on whether the first operation information acquired in response to the first transmission request is the same as the operation information acquired when the first security sensor started and whether the second operation information acquired in response to the second transmission request is the same as the operation information acquired when the second security sensor started. Specifically, if the first operation information is the same as the operation information acquired when the first security sensor started, the first security sensor is determined to be operating normally. Similarly, if the second operation information is the same as the operation information acquired when the second security sensor started, the second security sensor is determined to be operating normally. Conversely, if the first operation information is different from the operation information acquired when the first security sensor started, or if the second operation information is different from the operation information acquired when the second security sensor started, the respective security sensors are determined not to be operating normally.

If the operation information, which is the setting information of the security sensor, differs between the time of startup and the time of abnormal log detection, it is highly likely that the security sensor is not operating normally due to a malfunction or other issue. Therefore, if the operation information of the security sensor at the time of abnormal log detection differs from the operation information at the time of startup, it can be determined that the security sensor has a malfunction and is not operating normally. Conversely, if the operation information of the security sensor is the same at both the time of startup and the time of abnormal log detection, it can be determined that the security sensor is operating normally under at least the same conditions as at startup.

Here, the operation information of the security sensor compared by the reliability determination unit 107 at the time of abnormal log detection may be any operation information acquired before the detection of the abnormal log and does not necessarily have to be the operation information at the time of startup. However, if the security sensor is equipped with a secure boot function, the integrity of the software installed on the sensor is verified by the secure boot, so the accuracy and reliability of the operation information transmitted at startup are considered high.

Therefore, it may be desirable for the reliability determination unit 107 to determine the reliability related to the abnormal log by comparing it with the operation information acquired at the time of startup of the security sensor.

Similar to the first embodiment, in the present embodiment, the reliability is not limited to being expressed as high or low and may be determined numerically.

### (3) Operation of the Log Determination Device 100

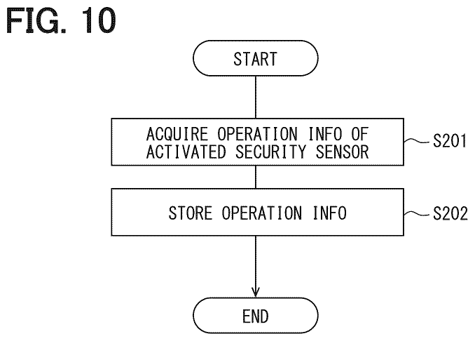

Next, the operation of the log determination device 100 in the present embodiment will be described with reference to FIG. 10. FIG. 10 illustrates the operation of the log determination device 100 in acquiring operation information when the security sensor starts.

The operation information acquisition unit 106 acquires the operation information of the security sensor that has started (S201). The operation information storage unit 111 stores the operation information acquired in S201 (S202).

Next, the operation of the log determination device 100 in the present embodiment will be described. The determination operation of the log determination device 100 in the present embodiment is basically the same as the log determination operation shown in FIG. 8 of the first embodiment. However, in the first embodiment, the reliability related to the abnormal log is determined in S107 using only the first operation information and the second operation information acquired in S106. In contrast, in the present embodiment, the reliability is determined in S107 using the first operation information and the second operation information acquired in S106 and the operation information of the security sensor acquired in S201 of FIG. 10.

### (4) Overview

As described above, according to the present embodiment, it is possible to determine the reliability related to the abnormal log using the operation information acquired when the security sensor starts without conducting a test on the security sensor, thereby reducing the processing load on the security sensor.

### 4. Third Embodiment

In the first and second embodiments, the log determination device 100 is described as requesting the transmission of operation information from the first security sensor and the second security sensor and determining the reliability related to the abnormal log using the operation information transmitted in response to the request. In the present embodiment, the configuration in which the log determination device 100 determines the reliability related to the abnormal log using the operation information acquired along with the security log will be described, focusing on the differences from the first and second embodiments. Since the configuration of the log determination device 100 in the present embodiment is the same as that in the first embodiment, it will be described with reference to FIG. 6.

### (1) Configuration of the Security Sensor

In the present embodiment, the operation information generation unit 13 of the security sensor generates operation information of the security sensor when the log generation unit 11 generates a security log. The transmission unit 14 then transmits the security log generated by the log generation unit 11 and the operation information generated by the operation information generation unit 13 to the log determination device 100.

In the present embodiment, the transmission unit 14 transmits the security log and the operation information as separate data to the log determination device 100. However, the operation information generated by the operation information generation unit 13 may be stored in the context data of the security log generated by the log generation unit 11. In this case, the operation information acquisition unit 106 of the log determination device 100 acquires the operation information stored in the context data by acquiring the security log.

### (2) Configuration of the Log Determination Device 100

In the present embodiment, the operation information acquisition unit 106 acquires the operation information along with the security log. Here, even if the abnormal log detection unit 103 detects an abnormal log, the request generation unit 104 in the present embodiment does not generate a first transmission request requesting the transmission of the first operation information to the first security sensor. This is because the first operation information is already acquired from the first security sensor along with the security log.

On the other hand, similar to the first embodiment, the request generation unit 104 generates a second transmission request requesting the transmission of the second operation information to the second security sensor and transmits the second transmission request from the request transmission unit 105.

### (3) Operation of the Log Determination Device 100

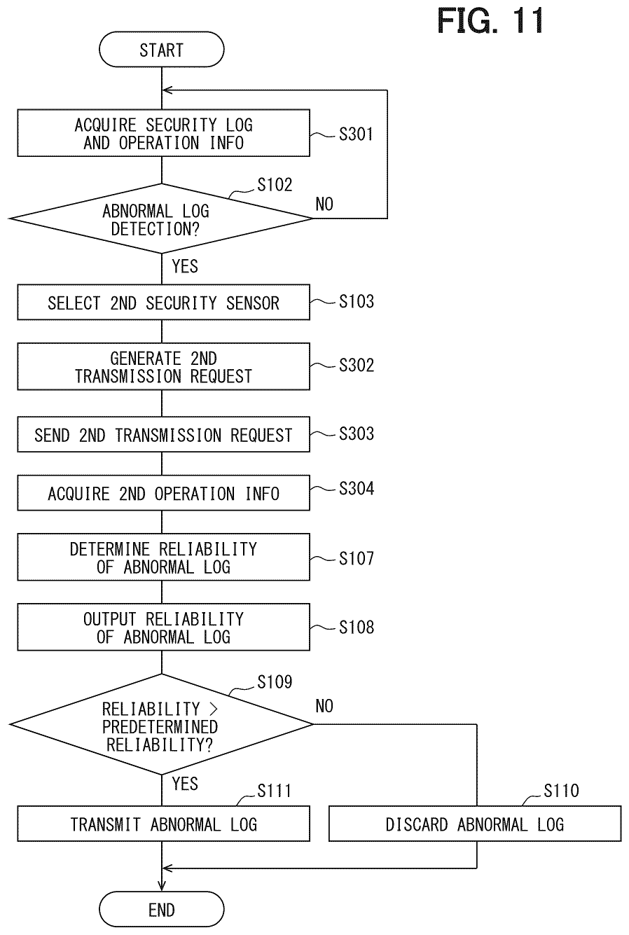

The operation of the log determination device 100 in the present embodiment will be described with reference to FIG. 11. The same processes as those in FIG. 8 of the first embodiment are denoted by the same reference numerals in FIG. 8, and the description thereof is omitted.

In the present embodiment, the operation information acquisition unit 106 acquires the operation information along with the security log when the log acquisition unit 101 acquires the security log (S301). In the first embodiment, the request generation unit 104 generated both the first transmission request and the second transmission request, whereas in the present embodiment, the request generation unit 104 generates only the second transmission request (S302). The request transmission unit 105 transmits the second transmission request to the second security sensor (S303). The operation information acquisition unit 106 then acquires the second operation information transmitted from the second security sensor (S304).

Next, the reliability determination unit 107 determines the reliability related to the abnormal log (S107). Here, in the first and second embodiments, the reliability is determined using the first operation information and the second operation information acquired by the operation information acquisition unit 106 in response to the first transmission request and the second transmission request. In contrast, in the present embodiment, the reliability is determined based on the first operation information acquired in S301 and stored in the operation information storage unit 111 and the second operation information acquired by the operation information acquisition unit 106 in response to the second transmission request.

(4) Overview

As described above, according to the present embodiment, it is not necessary to request the transmission of operation information from the security sensor that generated the abnormal log, thereby reducing the communication load on the in-vehicle network between the log determination device 100 and the ECU 10.

### 5. Modifications of Each Embodiment

In the first to third embodiments, the configuration in which the log determination processing is executed by the log determination device 100 mounted on a vehicle or provided outside the vehicle is described. In the present embodiment, the configuration in which the log determination processing executed by the log determination device 100 in each embodiment is realized by a log determination system 1 including multiple devices will be described.

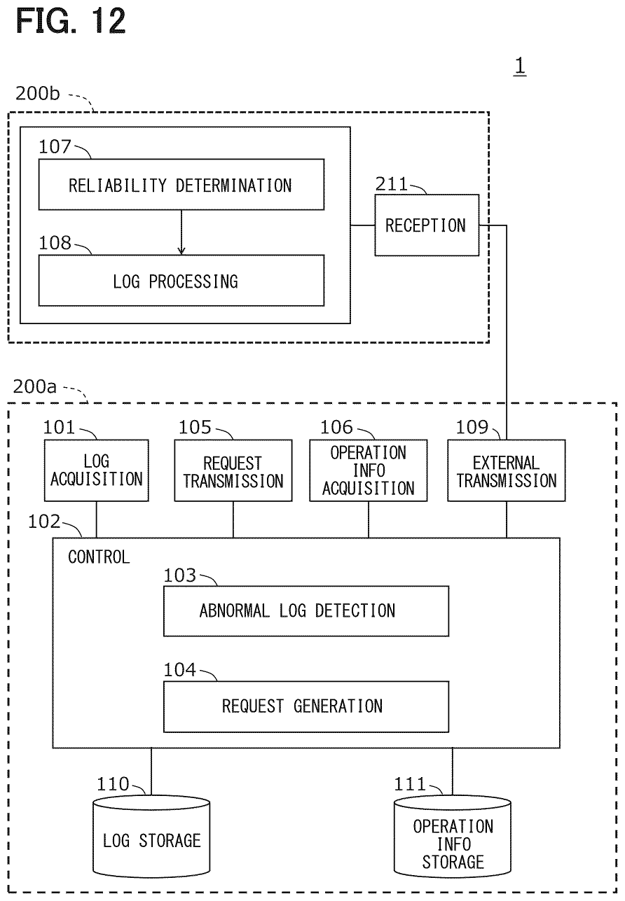

FIG. 12 is a diagram illustrating an example of the log determination system 1 in the present embodiment. The log determination system 1 includes a log determination device 200a mounted on a vehicle and a log processing device 200b provided outside the vehicle. The log determination device 200a includes the log acquisition unit 101, the request transmission unit 105, the operation information acquisition unit 106, the external transmission unit 109, the abnormal log detection unit 103, the request generation unit 104, the log storage unit 110, and the operation information storage unit 111, which are realized by the control unit 102 of the log determination device 100 in each embodiment. On the other hand, the log determination device 200b includes the reliability determination unit 107 and the log processing unit 108, which are realized by the control unit 102 of the log determination device 100 in each embodiment, and a reception unit 211 that acquires information transmitted from the log determination device 200a.

The configurations of the log determination devices 200a and 200b that are the same as those of the log determination device 100 in the first to third embodiments have the same functions as those in the first to third embodiments. However, in the present embodiment, the external transmission unit 109 transmits the security logs acquired by the log acquisition unit 101 and the operation information acquired by the operation information acquisition unit 106 in response to the requests generated by the request generation unit 104 to the log processing device 211.

The reception unit 211 of the log determination device 200b acquires the security logs and operation information transmitted from the log determination device 200a. The reliability determination unit 107 determines the reliability of the security logs acquired by the reception unit 211 based on the operation information acquired by the reception unit 211. The log processing unit 108 discards the abnormal logs based on the reliability or outputs the reliability and the abnormal logs to an SOC or the like that analyzes the abnormal logs.

In this modification, the log determination processing executed by the log determination device 100 in each embodiment is executed by either the log determination device 200a or the log determination device 200b.

According to this modification, the log determination device 200a mounted on the vehicle needs to transmit the security logs and operation information to the log determination device 200b provided outside the vehicle, which increases the communication load on the network between the log determination device 200a and the log determination device 200b. However, by executing the high-load processing of determining the reliability related to the abnormal logs outside the vehicle, it is possible to reduce the processing load on the devices mounted on the vehicle.

### 6. Overview

The features of the log determination device and the like in each embodiment of the present disclosure have been described above.

Since the terms used in each embodiment are examples, these may be replaced with terms that are synonymous or include synonymous functions.

The block diagram used for the description of each embodiment is obtained by classifying and arranging the configuration of the device by function. The blocks representing the respective functions may be implemented by any combination of hardware or software. Since the blocks represent the functions, such a block diagram may also be understood as disclosures of a method and a program for implementing the method.

The order of the functional blocks that can be understood as the processing, the flow, and the method described in each embodiment may be changed unless there are restrictions, such as a relationship in which one step uses the result of another step in the preceding step.

The terms such as first, second, to N-th (where N is an integer) used in each embodiment and in the claims are used to distinguish two or more configurations and methods of the same kind and are not intended to limit the order or superiority.

Examples of the form of the log determination device of the present disclosure include the following. Examples of a form of a component include a semiconductor device, an electronic circuit, a module, and a microcomputer. Examples of a form of a semi-finished product include an electric control unit (ECU) and a system board. Examples of a form of a finished product include a cellular phone, a smartphone, a tablet computer, a personal computer (PC), a workstation, and a server. In addition, devices with communication functions, and the like are included, and examples thereof include a video camera, a still camera, and a car navigation system.

Necessary functions such as an antenna and a communication interface may be added to the log determination device.

The log determination device of the present disclosure is assumed to be used for the purpose of providing various services by being used particularly on the server side. When such a service is provided, the log determination apparatus of the present disclosure is used, the method of the present disclosure is used, or/and the program of the present disclosure is executed.

The device can be implemented not only by dedicated hardware having the configurations and functions described in the embodiments, but also by a combination of a program, which is recorded on a storage medium such as a memory or a hard disk and is used for implementing the above configuration and features, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. Thereby, the latest functions can be provided at all times through program upgrade.

The log determination method of the present disclosure is mainly intended for a method of determining logs generated by ECUs configuring an electronic control system mounted on an automobile but may also be intended for a method of determining logs generated by general-purpose devices not mounted on an automobile.

What is claimed is:

1. A log determination method comprising:
acquiring a security log from a first security sensor that generates a security log when an event is detected;
acquiring first operation information indicating whether the first security sensor is operating normally and second operation information indicating whether a second security sensor different from the first security sensor is operating normally, respectively, when the security log indicates an abnormal log showing an abnormal event;
determining a reliability of the abnormal log based on the first operation information and the second operation information; and
outputting the reliability.

2. The log determination method according to claim 1, further comprising:
requesting the first operation information from the first security sensor and the second operation information from the second security sensor, respectively, when the security log is the abnormal log.

3. The log determination method according to claim 1, wherein:
the first operation information is a result of a test indicating whether the first security sensor is operating normally, and
the second operation information is a result of a test indicating whether the second security sensor is operating normally.

4. The log determination method according to claim 1, further comprising:
acquiring third operation information of the first security sensor when the first security sensor is activated, and
acquiring fourth operation information of the second security sensor when the second security sensor is activated,
wherein
in the determination of the reliability,
the first security sensor is determined to be operating normally when the first operation information is same as the third operation information, and
the second security sensor is determined to be operating normally when the second operation information is same as the fourth operation information.

5. The log determination method according to claim 1, wherein:
the first operation information is acquired together with the abnormal log, and
the second operation information is requested from the second security sensor.

6. The log determination method according to claim 1, wherein:
the second security sensor is a security sensor that generates a security log acquired within a predetermined time from time when the abnormal log is acquired.

7. The log determination method according to claim 1, wherein:
the second security sensor is a security sensor mounted on a same electronic control device as the first security sensor.

8. The log determination method according to claim 1, wherein:
the second security sensor is a security sensor mounted on an electronic control device that provides a security level equal to or lower than a security level of the electronic control device on which the first security sensor is mounted.

9. The log determination method according to claim 1, wherein:
the second security sensor is a security sensor that detects an event related to the abnormal event.

10. The log determination method according to claim 1, wherein:
the second security sensor is a security sensor from which no security log has been acquired within a predetermined time before the time when the abnormal log is acquired.

11. The log determination method according to claim 1, further comprising:
acquiring operation information, which is a result of a test indicating whether the second security sensor is operating normally, from the second security sensor at regular intervals or together with a security log generated by the second security sensor,
wherein
the second security sensor is a security sensor from which no test result has been acquired within a predetermined time before the time when the abnormal log is acquired.

12. The log determination method according to claim 1, wherein:
the second security sensor is a high-priority security sensor.

13. The log determination method according to claim 7, further comprising:
acquiring stop information, which is operation information indicating a stop of the second security sensor, from the second security sensor when the second security sensor stops,
wherein
the second security sensor is a security sensor from which the stop information has not been acquired.

14. The log determination method according to claim 1, executed by a log determination device mounted on a movable object, further comprising:
transmitting the abnormal log to outside the movable object when the reliability is higher than a predetermined reliability, and
not transmitting the abnormal log to outside the movable object when the reliability is lower than the predetermined reliability.

15. The log determination method according to claim 1, executed by a log determination device mounted on a movable object, further comprising:
transmitting the abnormal log, the reliability, and/or the first operation information and the second operation information to outside the movable object.

16. A log determination device mounted on a movable object, comprising:
a log acquisition unit configured to acquire a security log from a first security sensor that generates the security log when an event is detected;
an operation information acquisition unit configured to acquire first operation information indicating whether the first security sensor is operating normally and second operation information indicating whether a second security sensor different from the first security sensor is operating normally, respectively, when the security log indicates an abnormal log showing an abnormal event; and
a reliability determination unit configured to determine and output a reliability of the abnormal log based on the first operation information and the second operation information.

17. A non-transitory computer readable storage medium storing a log determination program executable by a log determination device, the program comprising instructions of:
acquiring a security log from a first security sensor that generates the security log when an event is detected;
acquiring first operation information indicating whether the first security sensor is operating normally and second operation information indicating whether a second security sensor different from the first security sensor is operating normally, respectively, when the security log indicates an abnormal log showing an abnormal event;
determining a reliability of the abnormal log based on the first operation information and the second operation information; and
outputting the reliability.
